(19) United States
(12) Patent Application Publication
(10) Pub. No.: US 2014/0154057 A1
(43) Pub. Date: Jun. 5, 2014

(54) FRANCIS TURBINE OR A FRANCIS PUMP OR A FRANCIS PUMP TURBINE

(71) Applicant: VOITH PATENT GMBH, Heidenheim (DE)

(72) Inventors: Thomas Kächele, Heidenheim (DE); Martin Giese, Heidenheim (DE)

(73) Assignee: VOITH PATENT GMBH, Heidenheim (DE)

(21) Appl. No.: 14/175,297

(22) Filed: Feb. 7, 2014

Related U.S. Application Data
(63) Continuation of application No. PCT/EP2012/003236, filed on Jul. 31, 2012.

(30) Foreign Application Priority Data
Sep. 7, 2011 (DE) 10 2011 112 521.7

(51) Int. Cl. F03B 3/18; F03B 3/12

(52) U.S. Cl. CPC F03B 3/18; F03B 3/125
USPC 415/159

(57) ABSTRACT

The present invention provides a Francis turbine or any other machine built according to the Francis principle. The machine includes a blade wheel that has multiple blades, with at least one of the blades being adjustable. A spiral housing encloses the blade wheel. A traverse ring with multiple traverses has a portion with larger traverses that extends over a portion of a circumference of the blade wheel and starts at a beginning of a spiral. The traverse ring also has a portion with smaller traverses that extends over a further circumference of the blade wheel up to an end of the spiral. An inner blade wheel ring is provided downstream of the traverse ring. Also included is an outer guide blade ring which is disposed upstream of the traverse ring.

### CROSS REFERENCE TO RELATED APPLICATIONS

This is a continuation of PCT application No. PCT/EP2012/003236, entitled “A FRANCIS TURBINE OR A FRANCIS PUMP OR A FRANCIS PUMP TURBINE,” filed Jul. 31, 2012, which is incorporated herein by reference.

### BACKGROUND OF THE INVENTION

1. Field of the Invention

The invention relates to a Francis turbine or Francis pump or Francis pump turbine, especially the guide apparatus of such a turbine which is used for supplying water to the blade wheel.

2. Description of the Related Art

Increasingly higher demands are placed on water turbines, such as Francis turbines, concerning the efficiency and the largest possible extension of the working range. A variable water flow rate ranging from extreme partial-load operation up to overload operation is desirable. The highest possible efficiency in combination with vibration-free running of the turbine is desirable in all load ranges.

Francis turbines are adapted to different operating conditions by adjusting the guide blades. Unsteady flow conditions still occur, especially under partial load, which lead to strong vibrations in the machine. Damage to material can consequently occur, in particular when the natural frequencies of components coincide with these vibrations. Further negative consequences of turbine vibrations are the effects on large machines when these vibrations affect the power grid. The irregularities in smooth running are injected via the generator into the power grid and have a negative effect in the form of power fluctuations. This leads to disadvantageous limitations in the turbine operating range. Consequently, critical partial-load ranges must be quickly passed during run-up of the turbine and must be avoided in permanent operation. Furthermore, there is an undesirable mutual influence on water-guiding systems.

In optimal operation of a Francis turbine, the water flows from the inlet volute in a radially symmetrical manner into the blade wheel, is deflected there by the blade wheel in such a way that it flows virtually axially into the draft tube, and is discharged there to the tailwater. Ideally the flow in the draft tube is virtually swirl-free. In operating states of the turbine outside of the best point, this freedom of swirling of the discharge flow after the blade wheel is no longer present. The causal link between the rotary component of the flow in the draft tube and the machine vibrations is known. Guide plates are introduced along the draft tube for stabilizing the flow in the draft tube and for suppressing the swirl. Such guide plates can be arranged as fins which are oriented in the axial direction. This configuration leads to a suppression of the swirl in the draft tube, but reduces efficiency.

Variable guide plates were developed for solving this problem. Such guide plates can be pivoted according to the operating conditions about an axis parallel to the machine axis. Further configurations of guide plates are oriented in parallel to the wall surfaces of the draft tube and thus prevent a detachment of flow areas by stabilizing the flow between the guide plates and the draft tube wall. Similar to the aforementioned fin-like structures, this construction also reduces the energy yield of the turbines. Furthermore, such static or variable constructions increase the costs for producing and maintaining turbines and are therefore a cost-relevant factor.

Further designs are also known, which are either complex or decrease the efficiency of the machine (see DE 102 13 774 A1).

### SUMMARY OF THE INVENTION

A problem that was not recognized until now is that all traverses of the traverse ring are provided with the same geometry, causing the spiral housing to not be ideally rotationally symmetrical. Especially in the case of pump turbines with different flow opening, this asymmetry is amplified thereby.

The invention is based on the object of providing a hydraulic machine configured in such a way that the asymmetry of the flow is reduced and the flow in the region of the traverse ring will become steady.

The invention provides an outer guide blade ring in addition to the traverse ring. The flow therefore exits from the spiral housing through the outer guide blade ring, passes through the traverse ring and finally through the inner guide blade ring.

A portion of the traverse ring with larger traverses extends over a part of the circumference of the blade wheel, starting from the start of the spiral, and a part of the traverse ring with smaller traverses extends over the further circumference of the blade wheel up to the end of the spiral. The size of the traverses therefore decreases until the end of the spiral. The decrease can be continuous.

One embodiment provides that the guide blades of the outer guide blade ring (and therefore the ring through which the flow passes first) are arranged up to the end of the spiral, but not at the beginning of the spiral.

The traverses of the traverse ring can be arranged in a generally weaker way in the circumferential direction up to the end of the spiral because the tensile load decreases towards the end of the spiral. As seen in a cross-sectional view perpendicularly to the axis, the traverses are dimensioned in a shorter way in a region close to the end of the spiral than before this region. This provides space for the guide blades of the outer guide blade ring.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows the relevant components of a conventional Francis turbine in a meridian sectional view;

FIG. 2 shows an axial sectional view of a Francis turbine in accordance with the invention; and

FIG. 3 shows the Francis turbine according to FIG. 2 in a sectional view perpendicularly to the axis.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

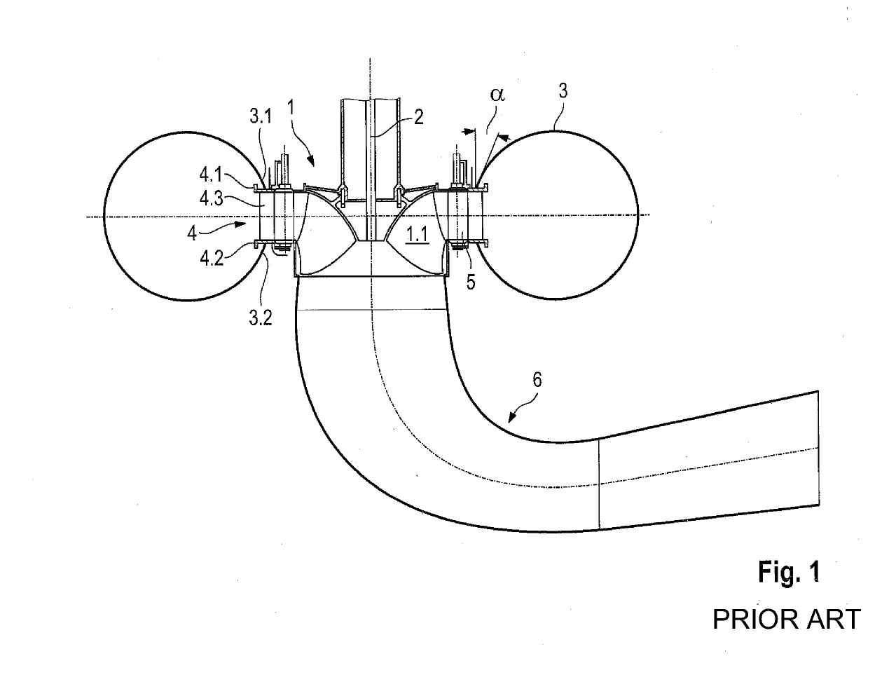

The Francis turbine shown in FIG. 1 includes a blade wheel 1 having a plurality of blades 1.1. The blade wheel 1 revolves about a rotational axis 2.

The blade wheel 1 is enclosed by a spiral housing 3. The spiral housing 3 has a circular cross-section and includes a circumferential slit-like opening towards the blade wheel 1. The opening slit is bounded by circumferential edges 3.1, 3.2.

A traverse ring 4 follows the circumferential slit formed by the edges 3.1, 3.2. The traverse ring 4 includes two traverse ring decks 4.1 and 4.2. A traverse 4.3 is used as a tie rod.

The regions of the circumferential edges 3.1, 3.2 of the spiral housing 3 are welded together with the traverse ring deck 4.1, 4.2.

A guide apparatus with guide blades 5 is provided between the traverse ring 4 and the blade wheel 1.

A draft tube 6 which includes several sections is connected to the blade wheel 1 in the direction of flow.

The illustration shows that the spiral housing 3 has a circular cross-section. The regions of the circumferential edges 3.1, 3.2 are inclined against the vertical at the connection points to the two traverse ring decks 4.1, 4.2. This means that the edge regions of the spiral housing 3 do not extend parallel to the rotational axis 2 of the blade wheel 1, but at an angle a of approximately 15 to 40°.

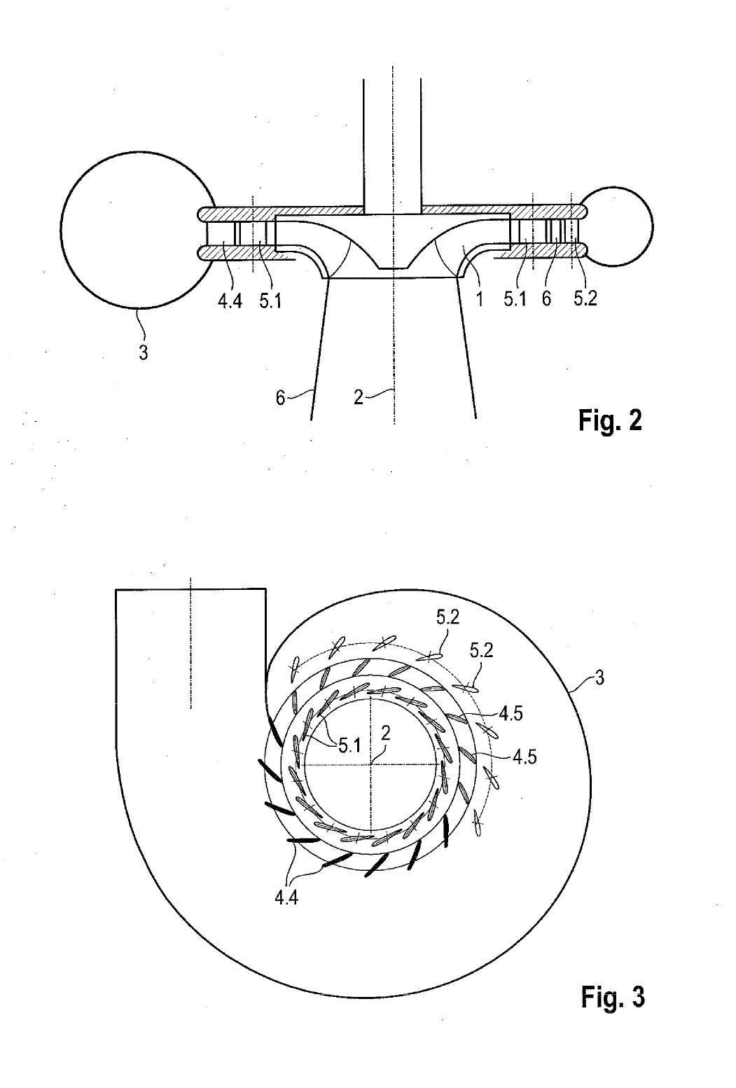

The Francis turbine in accordance with the invention as shown in FIGS. 2 and 3 includes a blade wheel, which is not shown here, and its rotational axis 2. The blade wheel includes a spiral housing 3. FIG. 3 shows a traverse ring 4 which includes a number of “large” traverses 4.4 and “small” traverses 4.5.

As is shown in FIGS. 2 and 3, the traverse ring portion with the larger traverses 4.4 commences at the start of the spiral and extends up to approximately half circumference of the blade wheel. This is followed by the portion of the traverse ring 4 with the small spirals 4.5. This portion of the traverse ring 4 extends up to the end of the spiral.

FIG. 3 shows a conventional inner guide blade ring with guide blades 5.1. This guide blade ring extends about the entire circumference of the blade wheel (not shown).

FIG. 3 further shows a second outer guide blade ring with guide blades 5.2. The second outer guide blade ring extends over only a part of the circumference. It starts where the traverse ring 4 with the small traverses 4.5 commences.

The tensile force required for clamping the spiral housing 3 in its radially inner region decreases in the circumferential direction of the spiral housing 3. That is why the traverses 4.3 can be provided with increasingly less thickness in the circumferential direction between the start of the spiral up to its end, e.g. by reducing its length (as shown in FIG. 3). Space is gained in this manner. The obtained space can be utilized for arranging the radially outer guide blades 5.2.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Blade wheel
1.1 Blades
2 Rotational axis
3 Spiral housing
3.1 Circumferential edge of the spiral housing
3.2 Circumferential edge of the spiral housing
3.3 First circular arc of larger diameter
3.4 Second circular arc of smaller diameter
3.5 Third circular arc of smaller diameter
4 Traverse ring
4.1 Traverse ring deck
4.2 Traverse ring deck
4.3 Traverse
4.4 Large traverse
4.5 Small traverse
5 Guide blade
5.1 Inner guide blade
5.2 Outer guide blade
6 Draft tube

What is claimed is:

1. A Francis turbine, or any other machine built according to the Francis principle, comprising:
a blade wheel having a plurality of blades, wherein at least one of said plurality of blades is adjustable;
a spiral housing which encloses said blade wheel;
a traverse ring having a plurality of traverses, wherein a portion of said traverse ring having larger traverses extends over a portion of a circumference of said blade wheel, starting at a beginning of a spiral, and a portion of said traverse ring having smaller traverses extends over a further circumference of said blade wheel up to an end of said spiral;
an inner blade wheel ring which is provided downstream of said traverse ring; and
an outer guide blade ring which is disposed upstream of said traverse ring.

2. A machine according to claim 1, wherein at least one of a thickness, a distance and a length of said plurality of traverses decreases one of continuously and abruptly over said circumference of said blade wheel, starting at said beginning of said spiral and ending at said end of said spiral, as seen in an axial section view.
